(19) United States
(12) Patent Application Publication
(10) Pub. No.: US 2009/0216410 A1
(43) Pub. Date: Aug. 27, 2009

(54) Automated machine management system with destination selection

(76) Inventors: William Edward Allen, Peoria, IL (US); Conrad Gene Grembowicz, Peoria, IL (US); Roger Dale Koch, Pekin, IL (US); Bryan James Everett, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/071,769

(22) Filed: Feb. 26, 2008

(51) Int. Cl. G06Q 10/00; G05D 1/00

(52) U.S. Cl. 701/50; 705/8

(57) ABSTRACT

A management system is provided having a data storage device configured to receive and store data from a loading machine and at least one of a plurality of transport machines. The data stored in the machines is indicative of at least one of a position and status of the loading machine and at least one of the plurality of transport machines. The management system also has a destination generator configured to estimate a location of an event and select and direct one of the plurality of transport machines to the estimated location. The estimated location is based on data received from the loading machine and data stored in the data storage device. The received and stored data are indicative of at least one of a current position and status of the loading machine and at least one of a previous position and status of the loading machine.

### TECHNICAL FIELD

The present disclosure is directed to an automated machine management system and, more particularly, to an automated machine management system capable of selecting a destination.

### BACKGROUND

In existing manual earthmoving systems, a haul truck operator typically positions a haul truck at a standby location until a loader is ready to transfer its load. When ready to transfer the load, the loader operator sends a signal to the haul truck operator. In one exemplary system, the loader operator moves the loader's bucket to a transfer position recognizable by the haul truck operator. Upon receiving the signal from the loader, the haul truck operator moves the haul truck into a load-transfer position where it receives the load from the loader.

The earthmoving industry has an increasing desire to improve the productivity of earthmoving systems and techniques, and under the above-described system, valuable time is wasted while the loader is waiting for the haul truck to move from the standby position to the load-transferring position. One attempt to reduce the load transfer time can be found in U.S. Pat. No. 6,988,591 (the '591 patent) issued to Uranaka et al. on Jan. 24, 2006. The '591 patent discloses an automated earthmoving system having a central coordinating system, hydraulic shovels, receiving vessels, and self-propelled vehicles. Each excavation site includes a hydraulic shovel and a plurality of receiving vessels. The hydraulic shovel excavates material and dumps it into one of the receiving vessels. When the receiving vessel currently being used contains a predetermined volume of material, it signals the central coordinating system to send a self-propelled vehicle to the excavation site. While traveling to the site, the self-propelled vehicle is guided by a GPS system indicating the location of the vessel. Upon reaching the excavation site, the self-propelled vehicle loads the vessel onto the vehicle's payload bed and travels to a processing facility. After a receiving vessel is removed from an excavation site, the hydraulic shovel begins dumping excavated material into the next adjacent receiving vessel. In addition, after the material has been removed from a vessel at the processing facility, the self-propelled vehicle takes the empty vessel back to any excavation site having available space for an empty vessel.

Although the system disclosed in the '591 patent may reduce the load transfer time, the cost and efficiency savings related to the reduced waiting time may be offset by increased time and resources expended when the loading position changes. In particular, the receiving vessels require independent pieces of equipment to move them to new locations because the receiving vessels are immobile. In the course of an excavation project, the loading position associated with a loader may change, thereby requiring the receiving vessel to be moved. The time and resources expended when relocating the receiving vessel may reduce efficiency and increase operating costs. In addition, the extra vessels may take up valuable space in worksites that have a limited amount of space in which to work.

The disclosed system is directed to overcoming one or more of the problems set forth above.

### SUMMARY

In one aspect, the present disclosure is directed toward a management system including a data storage device configured to receive and store data from a loading machine and at least one of a plurality of transport machines. The data stored in the machines is indicative of at least one of a position and status of the loading machine and at least one of the plurality of transport machines. The management system also includes a destination generator configured to estimate a location of an event and select and direct one of the plurality of transport machines to the estimated location. The estimated location is based on data received from the loading machine and data stored in the data storage device. The received and stored data are indicative of at least one of a current position and status of the loading machine and at least one of a previous position and status of the loading machine.

Consistent with a further aspect of the disclosure, a method is provided for automatically positioning a machine for an event. The method includes receiving and storing data from a loading machine and at least one of a plurality of transport machines. The method also includes automatically estimating a location of the event based on the received data and previously stored data. The method further includes automatically selecting and directing a transport machine toward the estimated location.

In yet another aspect, the present disclosure is directed toward a local machine including a data storage device configured to receive and store data from the local machine and at least one remote machine. The data is indicative of at least one of a position and status of the machine and the at least one of the remote machines. The local machine also includes a destination generator configured to estimate a location of an event and select and direct one of the remote machines to the estimated location. The estimated location is based on data received from the local machine and data stored in the data storage device. The received and stored data are indicative of at least one of a current position and status of the local machine and at least one of a previous position and status of the local machine.

### BRIEF DESCRIPTION OF THE DRAWINGS

FIG. 1 illustrates an exemplary worksite consistent with the disclosed embodiments;

FIG. 2 provides a schematic diagram illustrating certain components associated with the worksite of FIG. 1;

FIG. 3 illustrates another exemplary worksite consistent with the disclosed embodiments;

FIG. 4 provides a schematic diagram illustrating certain components associated with the worksite of FIG. 3;

FIG. 5 is a flow diagram and associated illustration of an exemplary disclosed method for positioning a transport machine to receive a payload from a loading machine; and

FIG. 6 is a continuation of the flow diagram and associated illustration of FIG. 5.

### DETAILED DESCRIPTION

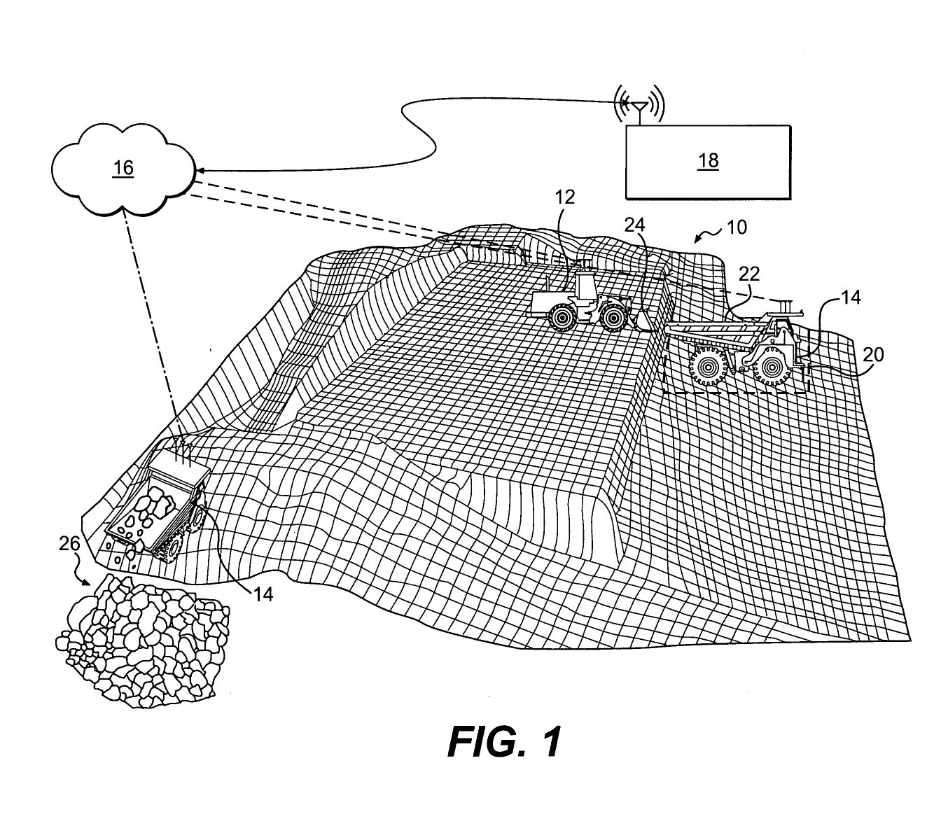

FIG. 1 illustrates an exemplary worksite 10 that has a centralized management system. Worksite 10 may include systems and devices that cooperate to perform a commercial or industrial task, such as mining, construction, energy exploration and/or generation, manufacturing, transportation, agriculture, or any task associated with other types of industries. According to the exemplary embodiment illustrated in FIG. 1, worksite 10 may include a mining environment that comprises one or more loading machines 12, one or more transport machines 14, a communication network 16, and a central management system 18.

As illustrated in FIG. 1, loading machines 12 and transport machines 14 may work together to move material from one location to another. Loading machines 12 may embody any machine that is configured to load material onto one or more transport machines 14. For example, loading machines 12 may include bucket-type excavating machines, electromagnetic-lift devices, backhoe loaders, dozers, etc. Transport machines 14 may embody any machine that is configured to transport materials within worksite 10 such as, for example, articulated trucks, dump trucks, or any other truck adapted to transport materials. The number, sizes, and types of machines illustrated in FIG. 1 are exemplary only and not intended to be limiting. Accordingly, it is contemplated that worksite 10 may include additional, fewer, and/or different components than those listed above. For example, worksite 10 may include a skid-steer loader, a track-type tractor, material transfer vehicle, or any other suitable fixed or mobile machine that may contribute to the operation of work site 10.

Each loading machine 12 may be associated with a loading area 20 at which a selected transport machine 14 may be positioned during a payload transferring event. For example, when loading machine 12 is ready to transfer a payload and transport machine 14 is positioned within loading area 20, a payload receiving portion 22 of transport machine 14 may be positioned underneath a payload transferring portion 24 of loading machine 12 so that a payload may be transferred from loading machine 12 to transport machine 14. In addition, loading area 20 may be located relative to loading machine 12 and may move as the operating area of loading machine 12 may change.

It is contemplated that worksite 10 may also include one or more unloading areas 26 where transport machines 14 may unload their payloads. Unloading areas 26 may be any kind of unloading site such as, for example, a processing facility, a rubble pile, or any other location where it may be desired to unload material being transported by transport machine 14.

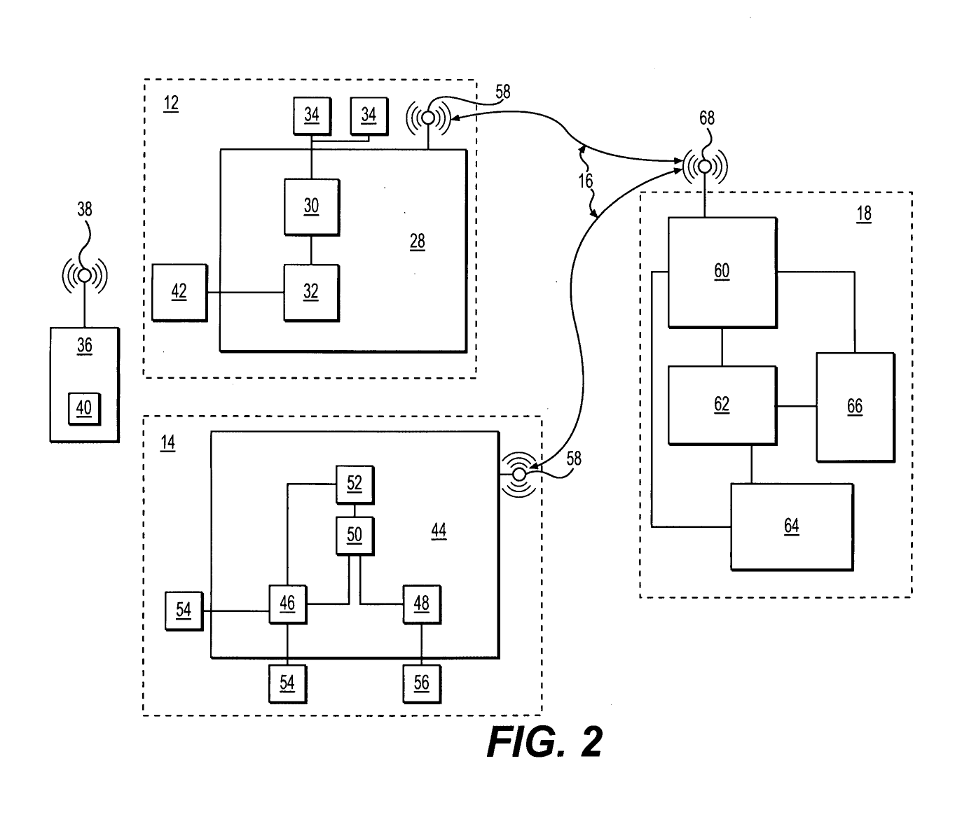

As illustrated in FIG. 2, each loading machine 12 may include a control system 28 taking any form such as, for example, a computer based system, a microprocessor based system, a microcontroller, or any other suitable control type circuit or system. Control system 28 may be located anywhere within the associated loading machine 12 and may include various components for running software applications designed to regulate various subsystems of the associated loading machine 12. For example, control system 28 may include a central processing unit (CPU), a random access memory (RAM), input/output (I/O) elements, etc. Furthermore, control system 28 may include a position monitor 30 and a loading monitor 32 for collecting, processing, and transmitting data related to the position, orientation, and status of the associated loading machine 12. It is contemplated that control system 28 may have more, less, or different components than those illustrated in FIG. 2.

Position monitor 30 may receive positioning and orientation data from one or more global positioning system (GPS) satellites via at least one GPS receiver 34 to determine the location of the associated loading machine 12 in relation to a global set of coordinates. Position monitor 30 may be a computer based system and include various components for running software applications designed to determine the position and orientation of the associated loading machine 12. For example, position monitor 30 may include a central processing unit (CPU), a random access memory (RAM), input/output (I/O) elements, etc.

In operation, each GPS receiver 34 may communicate with one or more GPS satellites to determine its position with respect to a selected coordinate system. GPS receivers 34 may be attached to one or more locations on the associated loading machine 12. For example, GPS receivers 34 may be placed at opposing ends of the associated loading machine 12 to determine the position of each end. By knowing the position of each end of the associated loading machine 12, position monitor 30 may determine the orientation and location of the associated loading machine 12.

It is contemplated that position monitor 30 may also receive positioning data from a local positioning unit 36 via one or more wireless communication devices 38 to supplement GPS receivers 34, if desired. Local positioning unit 36 may enable GPS receivers 34 to more accurately monitor the position of the associated loading machine 12. In addition, local positioning unit 36 may be a reference station at or near worksite 10 and may include any system for determining the position of loading machines 12 in a coordinate system. Furthermore, local positioning unit 36 may be placed away from loading machines 12 at a surveyed location with a known position. Local positioning unit 36 may be part of a differential GPS (DGPS), and may include a GPS receiver 40. GPS receiver 40 may be used to determine the position of local positioning unit 36. Any discrepancy between the actual, known position of local positioning unit 36 (as established by survey) and its determined position obtained using GPS receiver 40 may be considered to be error on the part of GPS receiver 40. A correction factor may be generated to compensate for any discrepancy and may be used to correct errors in the determined positions of local positioning unit 36 that are obtained using GPS receiver 40. This correction factor may also be applied to determined positions obtained using other GPS receivers in the vicinity. Accordingly, the correction factor may be used to modify the determined position of loading machines 12 that are obtained using GPS receivers 40. Use of this correction factor may enable position monitor 30 to more accurately determine the position of the associated loading machine 12. It is further contemplated that other corrective techniques may be employed for supplementing GPS receivers 34, if desired.

Loading monitor 32 may receive signals from one or more sensors 42 to determine a status of loading machine 12 (i.e., whether loading machine 12 is ready to transfer a payload, is currently transferring a payload, or has completed a payload transfer). Loading monitor 32 may be a computer based system and may include various components for running software applications designed to determine a status of loading machine 12. For example, loading monitor 32 may include a central processing unit (CPU), a random access memory (RAM), input/output (I/O) elements, etc.

Sensors 42 may include any kind of sensing device capable of measuring operational parameters of loading machine 12 indicative of the status of loading machine 12. For example, the parameters may include a position of payload transferring portion 24, an amount of material in the work implement, or any other parameter capable of indicating a status of loading machine 12.

Similar to loading machines 12, each transport machine 14 may include a control system 44. Control system 44 may take any form such as, for example, a computer based system, a microprocessor based system, a microcontroller, or any other suitable control type circuit or system. Control system 44 may be located anywhere within the associated transport machine 14 and may include various components for running software applications designed to regulate various subsystems of the associated transport machine 14. For example, control system 44 may include a central processing unit (CPU), a random access memory (RAM), input/output (I/O) elements, etc. Furthermore, control system 44 may include a position monitor 46, an obstacle monitor 48, a path generator 50, and a path tracker 52. These components may communicate with each other to guide transport machine 14 along a generated path within worksite 10. It is contemplated that control system 44 may have more, less, or different components than those illustrated in FIG. 2.

Position monitor 46 may be similar to position monitor 30. In particular, position monitor 46 may receive positioning and orientation data from one or more global positioning system (GPS) satellites via at least one GPS receiver 54 to determine the location of the associated transport machine 14 in relation to a global set of coordinates. Furthermore, it is contemplated that position monitor 46 may receive positioning data from local positioning unit 36 via wireless communication device 38 to supplement GPS receivers 54 in a manner similar to that used by position monitor 30 to supplement GPS receivers 34. Position monitor 46 may be a computer based system and include various components for running software applications designed to determine the position and orientation of the associated transport machine 14. For example, position monitor 46 may include a central processing unit (CPU), a random access memory (RAM), input/output (I/O) elements, etc.

Obstacle monitor 48 may receive data from one or more sensors 56 indicative of objects that may be within the vicinity of transport machine 14. Sensors 56 may be situated at any location on transport machine 14 that may facilitate the detection of nearby objects. Upon detecting such objects, sensors 56 may transmit signals to obstacle monitor 48. Upon receiving the signals, obstacle monitor 48 may transmit the location of potential obstacles to path generator 50. Obstacle monitor 48 may be a computer based system and include various components for running software applications designed to determine the location of various worksite objects. For example, obstacle monitor 48 may include a central processing unit (CPU), a random access memory (RAM), input/output (I/O) elements, etc. In addition, sensors 56 may be any combination of ultrasonic sensors, radar sensors, optical sensors, or any other type of sensor capable of detecting the location of various obstacles relative to transport machine 14.

Path generator 50 may create a travel path for transport machine 14 based on position and orientation data from position monitor 46, obstacle data from obstacle monitor 48, a map of worksite 10 (not shown), and destination data transmitted from central management system 18. Path generator 50 may be a computer based system including various components for running software applications designed to create a travel path for transport machine 14. For example, path generator 50 may include a central processing unit (CPU), a random access memory (RAM), input/output (I/O) elements, etc.

Path tracker 52 may guide transport machine 14 along the path created by path generator 50 by utilizing position and orientation data from position monitor 46. In addition, path tracker 52 may include various components for running software applications designed to guide transport machine 14 along the path generated by path generator 50. For example, path tracker 52 may include a central processing unit (CPU), a random access memory (RAM), input/output (I/O) elements, etc. Path tracker 52 may utilize any number of algorithms designed to keep transport machine 14 traveling along the path generated by path generator 50. Furthermore, path tracker 52 may send signals to a steering system (not shown) based on calculations made by the algorithm. The steering system may adjust the course of transport machine 14 based on signals transmitted by path tracker 52.

Loading machine position, orientation, and status data and transport machine position and orientation data may be transmitted to central management system 18 via communication system 16 and communication devices 58. Communication devices 58 may be located anywhere on loading machines 12 and transport machines 14. Control systems 28 and 44 may share communication devices 58 with other subsystems of loading machines 12 and transport machines 14, respectively. Alternatively, it is contemplated that control system 28 and/or control system 44 may have their own communication devices 58 independent of other subsystems of loading machines 12 and transport machines 14, if desired. Furthermore, communication devices 58 may be any device capable of wirelessly sending and receiving data such as, for example, a transceiver.

Communication network 16 may include any network that provides two-way communication between loading machines 12, transport machines 14, and an off-board system, such as central management system 18. For example, communication network 16 may communicatively couple loading machines 12 and transport machines 14 to central management system 18 across a wireless networking platform such as, for example, a satellite communication system. Alternatively and/or additionally, communication network 16 may include one or more broadband communication platforms appropriate for communicatively coupling loading machines 12 and transport machines 14 to management system 18 such as, for example, cellular, Bluetooth, microwave, point-to-point wireless, point-to-multipoint wireless, multipoint-to-multipoint wireless, or any other appropriate communication platform for networking a number of components.

Central management system 18 may take any form such as, for example, a computer based system, a microprocessor based system, a microcontroller, or any other suitable control type circuit or system and may be located in a central facility (not shown) either on or off of worksite 10. In addition, central management system 18 may include various components for running software applications designed to monitor worksite 10 and generate destinations for transport machines 14. For example, central management system 18 may include a central processing unit (CPU), a random access memory (RAM), input/output (I/O) elements, etc. Furthermore, central management system 18 may include a communication interface 60, a data storage device 62, a destination generator 64, and a loading area monitor 66.

Communication interface 60 may include one or more elements configured for two-way data communication between central management system 18 and remote systems (e.g., loading machines 12 and transport machines 14) via a communication device 68. For example, communication interface 60 may include one or more modulators, demodulators, multiplexers, demultiplexers, network communication devices, wireless devices, antennas, modems, or any other devices configured to support a two-way communication interface between central management system 18 and remote systems or components. It is contemplated that communication device 68 may be any device capable of receiving and sending data such as, for example, a transceiver.

Data storage device 62 may receive loading machine position, orientation, and status data and transport machine position and orientation data from loading machines 12 and transport machines 14 via communication interface 60. Such data may be received continuously, at predetermined intervals, or upon a request initiated by destination generator 64 and/or loading area monitor 66. Data storage device 62 may organize the position, orientation, and status data in a format such as, for example, a database, a spreadsheet, or any other format conducive to determining a location of a loading area 20 to which a selected transport machine 14 may be guided. In addition, data storage device 62 may be any type of electronic data storage device capable of storing data.

Destination generator 64 may generate a destination for each transport machine 14. Each generated destination may be used by path generators 50 and may be located within loading areas 20 or unloading areas 26. In addition, the generated destination may be based on data stored in data storage device 62. When generating a destination, destination generator 64 may analyze the data stored in data storage device 62 to determine a trend or pattern. For example, the data associated with a particular loading machine 12 may indicate that during each previous payload transferring event, loading machine 12 may have filled the payload receiving portion 22 of each transport machine 14 after three payload transfers. The data may also indicate that loading area 20 may have moved approximately 20 feet in a northerly direction after the payload bed of every third transport machine 14 was fully loaded. It is contemplated that destination generator 64 may use any number of parameters to determine trends or patterns in the stored data. Such parameters may include, for example, previous locations of loading machine 12, previous locations where loading machine 12 transferred material to transport machine 14, and the last time loading area 20 changed locations.

Destination generator 64 may compare the trend to the current status of loading machine 12 (i.e. whether or not loading machine 12 is currently transferring a payload to transport machine 14, how many payloads has been transferred to transport machine 14, and how many transport machines 14 have been fully loaded since the last time loading area 20 has moved) and a current status of the transport machine 14 that participated in the most recent payload transferring event performed by loading machine 12. Based on the comparison, destination generator 64 may decide whether or not to send an available transport machine 14 to loading area 20.

Destination generator 64 may select an available transport machine 14 based on any factor such as, for example, the relative location of transport machine 14 to the estimated location of loading area 20, the ore type being conveyed by transport machine 14, the payload unloading destination of transport machine 14, total haul distance of transport machine 14, truck type, loader type, etc. In addition, destination generator 64 may determine whether or not a transport machine 14 may be available by analyzing data stored in data storage device 62. Such data may indicate whether transport machine 14 was positioned at a loading area 20 or an unloading area 26 during its most recent payload transferring event. If transport machine 14 was most recently positioned at loading area 20, it may still be carrying a payload and may not be available. However, if transport machine 14 was most recently positioned at unloading area 26, it may have already unloaded its payload and may be available. Once selected, transport machine 14 may use an estimated location of loading area 20 based on data from data storage device 62 to generate a path and travel toward loading area 20. It should be understood that destinations including unloading areas 26 may be generated in a manner similar to the example disclosed above.

Destination generator 64 may be a computer based system including various components for running software applications designed to analyze data from data storage device 62, select a transport machine 14, and estimate a location of either loading area 20 or unloading area 26. For example, destination generator 64 may include a central processing unit (CPU), a random access memory (RAM), input/output (I/O) elements, etc.

In some circumstances, the actual location of loading area 20 may be different from the estimated location generated by destination generator 64. This may be due to many factors such as, for example, insufficient data stored in data storage device 62, outdated data stored in data storage device 62, calculation errors, inherent sensor errors, or any other factor that may contribute to a difference between the actual and estimated locations of loading area 20. Loading area monitor 66 may monitor the actual and estimated locations and may select a course of action based on the discrepancy between the two locations.

Loading area monitor 66 may receive position and status data from loading machine 12 via communication interface 60 and/or data storage device 62 indicative of a current status of loading machine 12. If the data indicates that loading machine 12 is ready to transfer the payload, loading area monitor 66 may determine the actual location of loading area 20 based on the current position of loading machine 12. In addition, loading area monitor 66 may receive position data from the selected transport machine 14. If there is no discrepancy between the actual location of loading area 20 and the current position of transport machine 14 or the discrepancy between the actual location of loading area 20 and the current position of transport machine 14 is less than a predetermined threshold distance, loading area monitor 66 may permit the payload transfer event to occur without modifying the position of transport machine 14. However, if the discrepancy between the actual location of loading area 20 and the current position of transport machine 14 is greater than the predetermined threshold distance, loading area monitor 66 may reposition transport machine 14 to the actual location of loading area 20. The threshold distance may be any distance beyond which, transport machine 14 may not be adequately positioned to receive a payload from loading machine 12.

If the position of transport machine 14 is modified, loading area monitor 66 may determine whether or not transport machine 14 reached the estimated location of loading area 20 generated by destination generator 64. If transport machine 14 reached the estimated location of loading area 20, loading area monitor 66 may decide whether or not to delete the data based on any number of factors or combination of factors such as, for example, whether the discrepancy between locations is less than a predetermined threshold, whether the discrepancy is getting larger or smaller with each subsequent payload transferring event, whether central management system 18 is operating in a learning mode, or any other factor or combination of factors that may justify deleting or not deleting data stored in data storage device 62. It is contemplated that if the data in data storage device 62 is deleted, central management system 18 may temporarily operate in a learning mode. The duration of the learning mode may be a predetermined number of payload transferring events, a predetermined period of time, or any combination thereof.

Loading area monitor 66 may be a computer based system including various components for running software applications designed to analyze data from loading machines 12, data storage device 62, and destination generator 64 and select a course of action. For example, loading area monitor 66 may include a central processing unit (CPU), a random access memory (RAM), input/output (I/O) elements, etc.

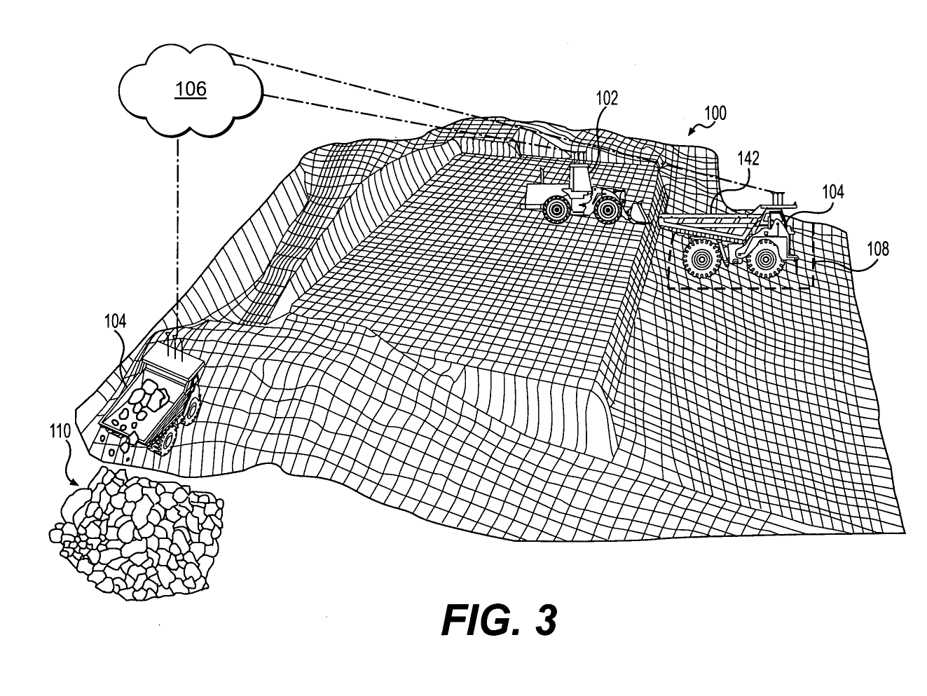

FIG. 3 illustrates an exemplary worksite 100 that has a decentralized management system. Similar to worksite 10, worksite 100 may include systems and devices that cooperate to perform a commercial or industrial task, such as mining, construction, energy exploration and/or generation, manufacturing, transportation, agriculture, or any task associated with other types of industries. According to the exemplary embodiment illustrated in FIG. 3, worksite 100 may include a mining environment that comprises one or more loading machines 102 similar to loading machines 12, transport machines 104 similar to transport machines 14, and a communication network 106 similar to communication network 16. In addition, each loading machine 102 may be associated with a loading area 108 similar to loading areas 20. Furthermore, worksite 100 may include one or more unloading areas 110 similar to unloading areas 26.

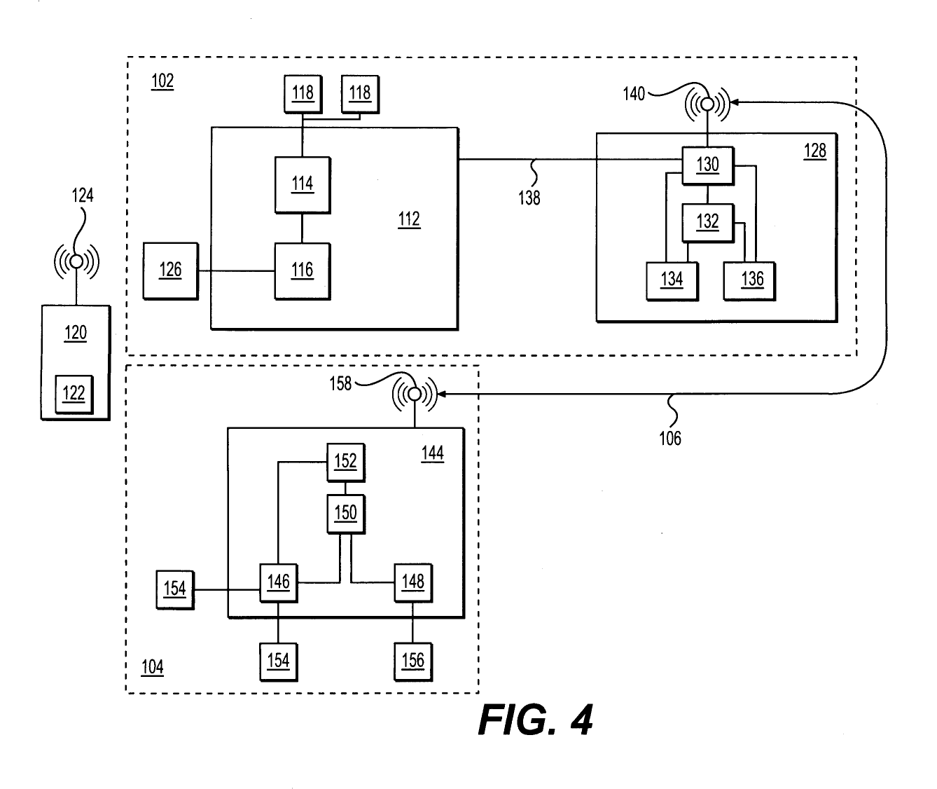

As illustrated in FIG. 4, each loading machine 102 may include a control system 112, which may be similar to control system 28 disclosed in FIG. 2 and above. Control system 112 may include a position monitor 114 and a loading monitor 116, which may be similar to position monitor 30 and loading monitor 32, respectively. Position monitor 114 may receive position and orientation data from GPS receivers 118, which may be part of a GPS system similar to the one disclosed above. In addition, data from GPS receivers 118 may be supplemented by a local positioning unit 120 and a GPS receiver 122 via a wireless communication device 124 in a manner similar to that disclosed above for local positioning unit 36 and GPS receiver 40. In addition, loading monitor 116 may receive signals from one or more sensors 126 to determine a status of loading machine 102 (i.e., whether loading machine 102 is ready to transfer a payload, is currently transferring a payload, or has completed a payload transfer). Sensors 126 may be similar to sensors 42 disclosed above.

Loading machine 102 may also include a management system 128, which may take any form such as, for example, a computer based system, a microprocessor based system, a microcontroller, or any other suitable control type circuit or system. In addition, management system 128 may include various components for running software applications designed to monitor the current status of loading machine 102 and select a transport machine 104 to receive a payload from loading machine 102. For example, management system 128 may include a central processing unit (CPU), a random access memory (RAM), input/output (I/O) elements, etc. Furthermore, management system 128 may include a communication interface 130, a data storage device 132, a destination generator 134, and a loading area monitor 136.

Communication interface 130 may provide a communication link between management system 128 and control system 112. Communication interface 130 may also provide a communication link between management system 128 and remote systems (e.g., other loading machines 102 and transport machines 104). For example, communication interface 130 may provide 2-way communication between control system 112 and management system 128 via a communication line 138. In addition, communication interface 130 may include one or more elements configured for two-way data communication between management system 128 and the remote systems via a communication device 140. Such elements may include, for example, one or more modulators, demodulators, multiplexers, demultiplexers, network communication devices, wireless devices, antennas, modems, or any other devices configured to support a two-way communication interface between management system 128 and remote systems or components. It is contemplated that communication device 140 may be any device capable of sending or receiving data such as, for example, a transceiver.

Data storage device 132 may receive loading machine position, orientation, and status data and transport machine position data from the associated loading machines 102 and transport machines 104 via communication interface 130. Such data may be received continuously, at predetermined intervals, or upon a request initiated by destination generator 134 and/or loading area monitor 136. Data storage device 132 may organize the position, orientation, and status data in a format such as, for example, a database, a spreadsheet, or any other format conducive to determining a loading position to which transport machine 104 may be guided. In addition, data storage device 132 may be any type of electronic data storage device capable of storing data.

Destination generator 134 may generate a destination located within loading area 108 for a selected transport machine 104. In addition, the generated destination may be based on data stored in data storage device 132. When generating a destination, destination generator 134 may analyze the data stored in data storage device 132 to determine a trend or pattern in a manner similar to the determination made by destination generator 64 that is disclosed above. For example, the data associated with loading machine 102 may indicate that during each previous payload transferring event, loading machine 102 may have filled a payload receiving portion 142 (referring back to FIG. 3) of each transport machine 104 after three payload transfers. The data may also indicate that loading area 108 may have moved approximately 20 feet in a northerly direction after the payload bed of every third transport machine 104 was fully loaded. It is contemplated that destination generator 134 may use any number of parameters to determine trends or patterns in the stored data. Such parameters may include, for example, previous locations of loading machine 102, previous locations where loading machine 102 transferred material to transport machine 104, and the last time loading area 108 changed locations.

After determining a trend in the stored data, destination generator 134 may compare the trend to the current status of loading machine 102 (i.e. whether or not loading machine 102 is currently transferring a payload to transport machine 104, how many payloads have been transferred to transport machine 104, and how many transport machines 104 have been fully loaded since the last time loading area 108 has moved) and a current status of the transport machine 104 that participated in the most recent payload transferring event performed by loading machine 102. Based on the comparison, destination generator 134 may decide whether or not to send an available transport machine 104 to loading area 108.

Destination generator 134 may select an available transport machine 104 based on any factor such as, for example, the relative location of transport machine 104 to the estimated location of loading area 108, the ore type being conveyed by transport machine 104, the payload unloading destination of transport machine 104, total haul distance of transport machine 104, truck type, loader type, etc. In addition, destination generator 134 may determine whether or not a transport machine 104 may be available by analyzing data stored in data storage device 132. Such data may indicate whether transport machine 104 was positioned at a loading area 108 or an unloading area 110 during its most recent payload transferring event. If transport machine 104 was most recently positioned at loading area 108, it may still be carrying a payload and may not be available. However, if transport machine 104 was most recently positioned at unloading area 110, it may have already unloaded its payload and may be available. Once selected, transport machine 104 may use an estimated location of loading area 108 based on data from data storage device 132 to generate a path and travel toward loading area 108.

Destination generator 134 may be a computer based system including various components for running software applications designed to analyze data from data storage device 132, select a transport machine 104, and estimate a location of loading area 108. For example, destination generator 134 may include a central processing unit (CPU), a random access memory (RAM), input/output (I/O) elements, etc.

Loading area monitor 136 may receive position and status data from control system 112 via communication line 138 indicative of a current status of loading machine 102. If the data indicates that loading machine 102 is ready to transfer the payload, loading area monitor 136 may determine the actual location of loading area 108 based on the current position of loading machine 102. In addition, loading area monitor 136 may receive position data from the selected transport machine 104. If there is no discrepancy between the actual location of loading area 108 and the current position of the selected transport machine 104 or the discrepancy between the actual location of loading area 108 and the current position of the selected transport machine 104 is less than a predetermined threshold distance, loading area monitor 136 may permit the payload transfer event to occur without modifying the position of transport machine 104. However, if the discrepancy between the actual location of loading area 108 and the current position of transport machine 104 is greater than the predetermined threshold distance, loading area monitor 136 may reposition transport machine 104 to the actual location of loading area 108. The threshold distance may be any distance beyond which, transport machine 104 may not be adequately positioned to receive a payload from loading machine 102.

If the position of transport machine 104 is modified, loading area monitor 136 may determine whether or not transport machine 104 reached the estimated location of loading area 108 generated by destination generator 134. If transport machine 104 reached the estimated location of loading area 108, loading area monitor 136 may decide whether or not to delete the data based on any number of factors or combination of factors such as, for example, whether the discrepancy between locations is less than a predetermined threshold, whether the discrepancy is getting larger or smaller with each subsequent payload transferring event, whether management system 128 is operating in a learning mode, or any other factor or combination of factors that may justify deleting or not deleting data stored in data storage device 132. It is contemplated that if the data in data storage device 132 is deleted, management system 128 may temporarily operate in a learning mode. The duration of the learning mode may be a predetermined number of payload transferring events, a predetermined period of time, or any combination thereof.

Loading area monitor 136 may be a computer based system including various components for running software applications designed to analyze data from loading machines 102, data storage device 132, and destination generator 134 and select a course of action. For example, loading area monitor 136 may include a central processing unit (CPU), a random access memory (RAM), input/output (I/O) elements, etc.

Each transport machine 104 may include a control system 144, which may include a position monitor 146, an obstacle monitor 148, a path generator 150, and a path tracker 152. Control system 144 and its associated components may be similar to control system 44 and its associated components disclosed in FIG. 2 and above. Furthermore, transport machine 104 may include GPS receivers 154 similar to GPS receivers 54 disclosed above and sensors 156 similar to sensors 56 disclosed above. It is contemplated that GPS receivers 154 may be supplemented by local positioning unit 120 and GPS receiver 122 in a manner similar to that disclosed above for local positioning unit 36 and GPS receivers 40. Control system 144 may also include a communication device 158 for transmitting location and status data to and receiving generated destinations from remote systems (e.g., management systems 128). It is contemplated that communication device 158 may be any device capable of sending or receiving data such as, for example, a transceiver.

It is contemplated that although FIG. 4 illustrates only control system 112 having a management system 128, control system 144 may also have a management system 128. It is further contemplated that in an alternate embodiment, control system 144 may have a management system 128 and control system 112 may not.

Communication network 106 may include any network that provides two-way communication between loading machines 102 and transport machines 104. For example, communication network 106 may communicatively couple loading machines 102 and transport machines 104 across a wireless networking platform such as, for example, a satellite communication system. Alternatively and/or additionally, communication network 106 may include one or more broadband communication platforms appropriate for communicatively coupling loading machines 102 to transport machines 104 such as, for example, cellular, Bluetooth, microwave, point-to-point wireless, point-to-multipoint wireless, multipoint-to-multipoint wireless, or any other appropriate communication platform for networking a number of components.

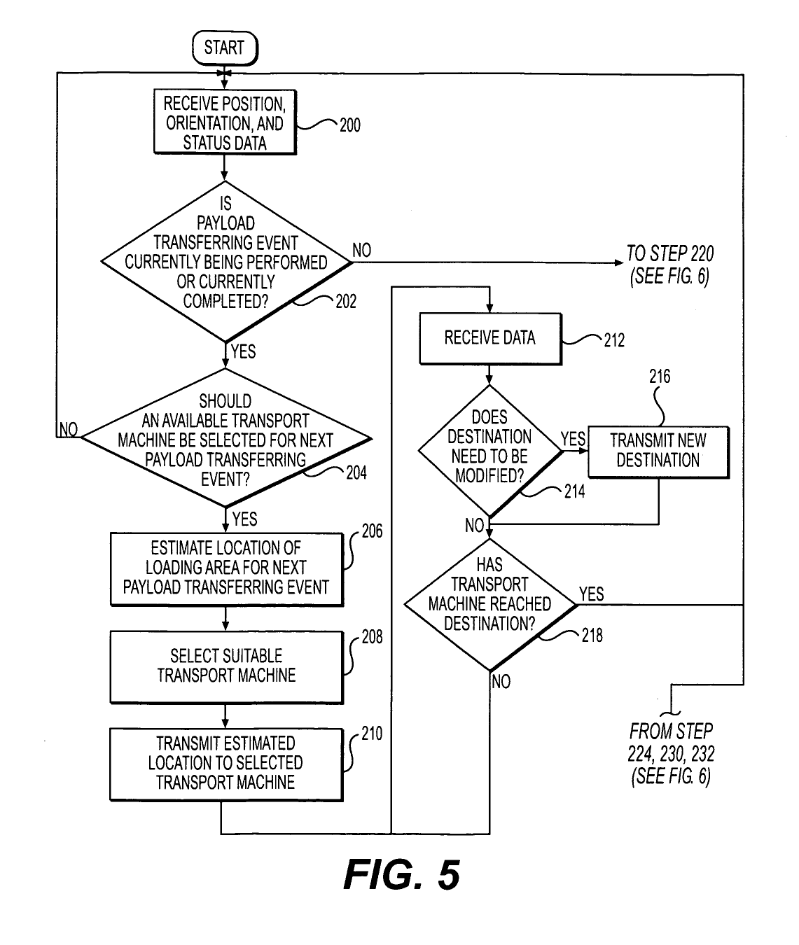

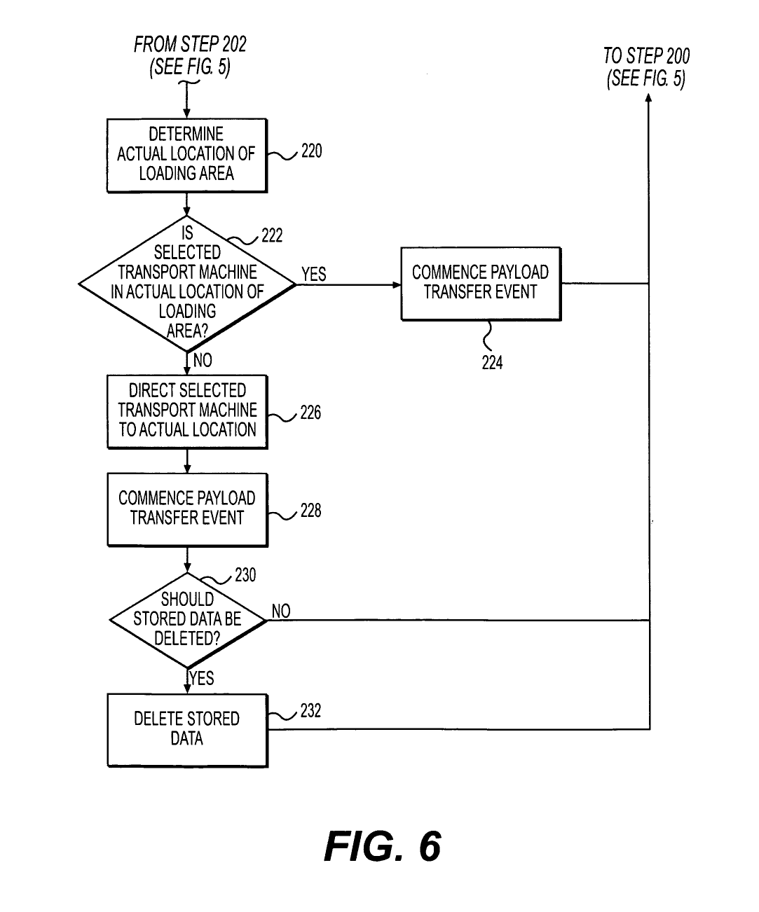

FIGS. 5 and 6, which are discussed in the following section, illustrate the operation of worksites 10 and 100 utilizing embodiments of the disclosed system. FIGS. 5 and 6 illustrate an exemplary method for positioning transport machines 14, 104 to receive a payload from loading machine 12, 102, respectively.

### INDUSTRIAL APPLICABILITY

The disclosed system may reduce the loader waiting time without increasing the amount of equipment needed to operate the worksite. In particular, a management system may analyze positioning and status data to determine loading and unloading trends. The management system may use these trends to anticipate when and where a loader may be ready to load a haul truck (or a transport machine). In addition, the management system may use the determined trends to anticipate where and when a haul truck may unload its payload. Because the time and location of the loading and unloading events may be anticipated, the haul trucks may position themselves without having to wait for signals from the loader, thereby reducing the loader waiting time. The operation of the management system will now be explained.

FIG. 5 illustrates a flow diagram depicting an exemplary method for positioning transport machine 14 to receive a payload from loading machine 12. It should be understood that although the method is disclosed being performed by components of worksite 10, the method may also be performed in a similar manner by components of worksite 100. The method may begin when central management system 18 receives current position, orientation, and status data from loading machine 12 (step 200). The status data may indicate in which state (e.g., ready to transfer a payload, currently transferring a payload, or completed a payload transfer) loading machine 12 may be operating.

Destination generator 64 may review the received status data and determine the current state in which loading machine 12 is operating (step 202). If loading machine 12 is either performing a payload transferring event or has completed a payload transferring event (step 202: Yes), destination generator 64 may determine whether to select an available transport machine 14 for the next payload transferring event (step 204). It is contemplated that loading machine 12 may be considered operating in a “currently completed payload transfer” state if it is not transferring a payload and it is not ready to transfer a payload. It is further contemplated that loading machine 12 may be considered “currently ready to transfer a payload” when it is positioned adjacent to loading area 20 and is carrying a payload to be transferred to transport machine 14. If loading machine 12 is ready to transfer a payload (i.e., not performing a payload transferring event or has currently completed a payload transferring event, that is, ready to transfer a payload) (step 202: No), step 220 may be performed. Step 220 and the ensuing steps after step 220 are disclosed in FIG. 6 and below.

The decision to select an available transport machine 14 may be made by analyzing data stored in data storage device 62 indicating a status of the transport machine 14 that received the most recent payload transfer from loading machine 12. For example, after three payload transferring events, payload receiving portion 22 of an associated transport machine 14 may be filled to its capacity. If loading machine 12 has performed three payload transferring events with the same transport machine 14 (or the current payload transferring event is the third consecutive payload transferring event with the same transport machine 14), the status of transport machine 14 may be “full”. Therefore, transport machine 14 may not be able to receive another load from loading machine 12, and another transport machine 14 may be needed for the next payload transferring event.

If destination generator 64 determines that there is no need to select another transport machine 14 for the next payload transferring event (step 204: No), step 200 may be repeated (i.e., central management system 18 may receive current position, orientation, and status data from loading machine 12). However, if destination generator 64 determines that there is a need to select another transport machine for the next payload transferring event (step 204: Yes), destination generator 64 may estimate the location of loading area 20 for the next payload transferring event (step 206). When estimating the location of loading area 20, destination generator 64 may analyze the data stored in data storage device 62 to determine a trend or pattern. For example, the data may indicate that loading area 20 may have moved approximately 20 feet in a northerly direction after the payload receiving portion 22 of every third transport machine 14 was fully loaded. It is contemplated that destination generator 64 may use any number of parameters to determine trends or patterns in the stored data. Such parameters may include, for example, previous locations of loading machine 12, previous locations where loading machine 12 transferred material to transport machine 14, and the last time loading area 20 changed locations.

After estimating the next loading position, destination generator 64 may examine the current positions and destinations of all available transport machines 14 and select the most suitable transport machine 14 (step 208). Available transport machines 14 may be any transport machine 14 that is not assigned to a loading area 20 or unloading area 26 and is not currently carrying a payload. In addition, the suitability of an available transport machine 14 may be determined based on any number of criteria such as, for example, the relative location of transport machine 14 to the estimated location of loading area 20, the ore type being conveyed by transport machine 14, the payload unloading destination of transport machine 14, total haul distance of transport machine 14, truck type, loader type, etc. After selecting an available transport machine 14, destination generator 64 may transmit the estimated location of loading area 20 to control system 44 of the selected transport machine 14 (step 210). Control system 44 may use the estimated location of loading are 20 as a destination toward which transport machine 14 may be guided.

While transport machine 14 is traveling to the estimated location of loading area 20, central management system 18 may continue receiving position and status data from loading machine 12 and position data from the selected transport machine 14 (step 212). Destination generator 64 may analyze the data to determine if the current destination of the selected transport machine 14 needs to be modified (step 214). The destination of the selected transport machine 14 may need to be modified for any number of reasons. For example, the destination of the selected transport machine 14 may need to be modified if another transport machine 14 is currently positioned within the estimated location of loading area 20. This may occur when the other transport machine 14 is receiving its final payload from loading machine 12. While the transport machine 14 currently receiving a payload is positioned in the estimated location of loading area 20, the destination of the selected transport machine 14 may be modified so that the selected transport machine 14 may be directed to a “stand-by” location adjacent to the estimated location of loading area 20. Once the current payload transferring event is completed and the other transport machine 14 moves out of loading area 20, the selected transport machine 14 may be directed to the estimated location of loading area 20.

Another exemplary circumstance in which the destination of transport machine 14 may need to be modified, may occur when data received by central management system 18 generates an estimated location of loading area 20 greater than a threshold distance from the location previously transmitted to the selected transport machine 14. The threshold distance may be any distance such as, for example, the length of transport machine 14, the error rate of the GPS system on loading machine 12, or any other suitable threshold distance.

If destination generator 64 determines that the destination of the selected transport machine 14 needs to be modified (step 214: Yes), destination generator 64 may transmit the new destination to the selected transport machine 14 (step 216). If destination generator 64 determines that the destination of the selected transport machine 14 does not need to be modified (step 214: No) or after the modified destination has been transmitted to the selected transport machine 14, destination generator 64 may determine if the selected transport machine 14 has reached the transmitted destination (step 218). If transport machine 14 has not reached the transmitted destination (step 218: No), step 212 may be repeated (i.e., central management system 18 may receive position and status data from loading machine 12 and position data from the selected transport machine 14). However, if transport machine 14 has reached the transmitted destination (step 218: Yes), step 200 may be repeated (i.e., central management system 18 may receive current position, orientation, and status data from loading machine 12).

FIG. 6 illustrates a continuation of the method disclosed in FIG. 5. In particular, FIG. 6 illustrates the method when loading machine 12 is ready to transfer a load (step 202: No). If loading machine 12 is ready to transfer a load, loading area monitor 66 may determine the actual location of loading area 20 (step 220). The actual location of loading area 20 may be based on the position of loading machine 12 when loading machine 12 is ready to transfer a load. Loading area monitor 66 may compare the actual location of loading area 20 with the location of the selected transport machine 14 and determine whether transport machine 14 is positioned within loading area 20 (step 222). It is contemplated that transport machine 14 may be considered to be within the actual location of loading area 20 if the discrepancy between the two locations is less than a predetermined threshold distance. The threshold distance may be any distance beyond which, transport machine 14 may not be adequately positioned to receive a payload from loading machine 12. If transport machine 14 is within loading area 20 (step 222: Yes), loading area monitor 66 may direct loading machine 12 to begin transferring the payload to transport machine 14 (step 224) and then step 200 may be repeated (i.e., central management system 18 may receive current position, orientation, and status data from loading machine 12).

If transport machine 14 is not within loading area 20 (step 222: No), loading area monitor 66 may transmit the actual location of loading area 20 to control system 44, and control system 44 may direct transport machine 14 to the actual location of loading area 20 (step 226). After transport machine 14 is positioned within loading area 20, loading area monitor 66 may direct loading machine 12 to begin transferring the payload to transport machine 14 (step 228).

After the payload transfer event is commenced, loading area monitor 66 may determine whether the data relating to loading machine 12 that is stored within data storage device 62 should be deleted (step 230). Loading area monitor 66 may decide whether or not to delete the data based on any number of factors or combination of factors such as, for example, whether the discrepancy between locations is less than a predetermined threshold, whether the discrepancy is getting larger or smaller with each subsequent payload transferring event, whether central management system 18 is operating in a learning mode, or any other factor or combination of factors that may justify deleting or not deleting data stored in data storage device 62. If loading area monitor 66 decides not to delete the stored data (step 230: No), step 200 may be repeated (i.e., central management system 18 may receive current position, orientation, and status data from loading machine 12). However, if loading area monitor 66 decides to delete the stored data (step 230: Yes), loading area monitor 66 may delete the data relating to loading machine 12 that is stored within data storage device 62 (step 232). It is contemplated that if the data in data storage device 62 is deleted, central management system 18 may temporarily operate in a learning mode. The duration of the learning mode may be a predetermined number of payload transferring events, a predetermined period of time, or any combination thereof.

By anticipating the loading position utilized by the loader, the loader waiting time may be reduced without increasing the time and resources needed to accommodate loading position changes. In particular, the data on which the estimated loading position is based, may indicate repeating patterns indicating when the loading position for a particular loader may change. For example, the data may indicate that the loader changes its loading position to a particular location after three haul trucks (or transport machines) have been filled. When estimating a loading position, the disclosed management system may account for the loading position change, thereby reducing the waiting time and eliminating the need for additional resources when the loading position changes.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A management system comprising:
a data storage device configured to receive and store data from a loading machine and at least one of a plurality of transport machines, wherein the data is indicative of at least one of a position and status of the loading machine and at least one of the plurality of transport machines; and
a destination generator configured to estimate a location of an event and select and direct one of the plurality of transport machines to the estimated location, the estimate being based on data received from the loading machine and data stored in the data storage device, the received and stored data being indicative of at least one of a current position and status of the loading machine and at least one of a previous position and status of the loading machine.

2. The management system of claim 1, wherein the destination generator is configured to determine a trend in the stored data and base the estimate of the location of the event on the trend.

3. The management system of claim 2, wherein the destination generator is configured to modify the estimated location of the event in response to data received from the loading machine while the selected transport machine travels toward the estimated location and redirect the selected transport machine toward the modified estimated location.

4. The management system of claim 3, further including a destination location monitor configured to determine an actual location of the event based on data received from the loading machine, the data indicating a current position and status of the loading machine.

5. The management system of claim 4, wherein the destination location monitor directs the selected transport machine to the actual location when the actual and estimated locations are different.

6. The management system of claim 5, wherein the destination location monitor is configured to delete the data stored in the data storage device used to generate the estimated location in response to a discrepancy between the estimated and actual locations.

7. The management system of claim 1, wherein the data storage device and the destination generator are located remotely from the loading machine and the plurality of transport machines.

8. A method for automatically positioning a machine for an event, comprising:
receiving and storing data from a loading machine;
receiving and storing data from at least one of a plurality of transport machines;
automatically estimating a location of the event based on the received data and previously stored data; and
automatically selecting and directing a transport machine toward the estimated location.

9. The method of claim 8, further including determining a trend in the previously stored data and basing the estimate of the location of the event on the trend.

10. The method of claim 9, further including receiving data from the loading machine while the selected transport machine is traveling toward the estimated location, modifying the estimated location in response to the received data, and directing the selected transport machine to the modified estimated location.

11. The method of claim 10, further including determining an actual location of the event based on data received from the loading machine.

12. The method of claim 11, further including directing the selected transport machine to the actual location of the event when the estimated and actual locations of the event are different.

13. The method of claim 12, further including deleting the stored data used to generate the estimated location in response to a discrepancy between the estimated and actual locations of the event.

14. The method of claim 13, further including deleting the stored data used to generate the estimated location when the discrepancy between the estimated and actual locations of the event is greater than a threshold distance.

15. A local machine, comprising:
a data storage device configured to receive and store data from the local machine and at least one remote machine, the data being indicative of at least one of a position and status of the machine and the at least one of the remote machines; and
a destination generator configured to estimate a location of an event and select and direct one of the remote machines to the estimated location, the estimate being based on data received from the local machine and data stored in the data storage device, the received and stored data being indicative of at least one of a current position and status of the local machine and at least one of a previous position and status of the local machine.

16. The local machine of claim 15, wherein the destination generator is configured to determine a trend in the stored data and base the estimate of the location of the event on the trend.

17. The local machine system of claim 16, wherein the destination generator is configured to modify the estimated location of the event in response to data received from the local machine while the selected remote machine travels toward the estimated location and redirect the selected remote machine toward the modified estimated location.

18. The local machine of claim 17, further including a destination location monitor configured to determine an actual location of the event based on data received from the local machine, the data indicating a current position and status of the local machine.

19. The local machine of claim 18, wherein the destination location monitor directs the selected remote machine to the actual location when the actual and estimated locations are different.

20. The local machine of claim 19, wherein the destination location monitor is configured to delete the data stored in the data storage device used to generate the estimated location in response to a discrepancy between the estimated and actual locations.
